(19) United States
(12) Patent Application Publication
(10) Pub. No.: US 2020/0121547 A1
(43) Pub. Date: Apr. 23, 2020

(54) FUNCTIONAL CHAIR WITH MASSAGE BALL

(71) Applicant: JERAGENE KOREA CO., LTD., Jeju (KR)

(72) Inventor: Byeong Heon YANG, Seoul (KR)

(73) Assignee: JERAGENE KOREA CO., LTD., Jeju (KR)

(21) Appl. No.: 16/202,023

(22) Filed: Nov. 27, 2018

(30) Foreign Application Priority Data
Oct. 19, 2018 (KR) 10-2018-0125115

(51) Int. Cl. A61H 15/00; A47C 7/46

(52) U.S. Cl. CPC A61H 15/00; A61H 2015/0035; A61H 2201/0149; A47C 7/462

(57) ABSTRACT

The present invention relates to a functional chair with massage balls that is capable of allowing the massage balls to protrude outwardly therefrom through the manipulation of armrests to massage a user's muscles around the back and spine, thereby permitting the user's fatigue due to long sitting hours to be relieved. The functional chair includes: a seat; a seat support adapted to support the seat; a backrest having a plurality of massage holes formed penetratedly thereon; a backrest support having an inside partition extended from edges of an open surface; a pair of massage parts having the massage balls protruding from the massage holes or inserted into the massage holes; a pair of armrests adapted to rotate the massage parts; a seat connector adapted to fix the seat and the backrest thereto; and a stopper adapted to control rotation of the massage parts.

### BACKGROUND OF THE INVENTION

### Field of the Invention

The present invention relates to a functional chair with massage balls disposed on the backrest thereof, and more particularly, to a functional chair with massage balls that is capable of allowing the massage balls to protrude outwardly therefrom through the manipulation of armrests to massage a user's muscles around the back and spine, thereby permitting the user's fatigue due to long sitting hours to be relieved, and that is capable of performing massaging according to the user's selection.

### Background of the Related Art

Generally, a study or office chair used for study or work includes a seat for supporting a user's weight when he or she sits therein and a backrest disposed at the rear side of the seat to support his or her waist and back.

As the user sits in the study or office chair for long hours, his or her muscles around the waist, shoulders, or back of the neck may be often stiffened and painful due to fatigue accumulation.

Moreover, the use of personal computers has been popularized to cause workers in offices to sit in the office chairs for long hours, which undesirably makes various troubles, such as physical function troubles, spinal curvatures or lumbar injuries due to unstable postures, blood circulation troubles, chronic fatigue, and so on. As people's lack of exercise and their sitting time are increased, the above-mentioned troubles happen more frequently.

As people, especially, students, workers in offices, or drivers for transportation, who sit in chairs for long hours have been increased, recently, many interests in functional chairs capable of providing comfort and relaxing have been given.

So as to remove or release the physical function troubles occurring at the use of the existing general study or office chair, recently, functional chairs with various functions have been increasingly released to the market.

However, most of the conventional functional chairs on the market are configured just to apply a massage function to sofa type chairs like armchairs, and accordingly, it is basically difficult that they can be put into practice as study or office chairs.

Accordingly, there is a definite need to develop a functional massage chair capable of being used as a study or office chair and, if the massage function is selected by a user, providing a massage function of removing or releasing knots or stiffness of the user's muscles around the back of the neck or spine.

### SUMMARY OF THE INVENTION

Accordingly, the present invention has been made in view of the above-mentioned problems occurring in the prior art, and it is an object of the present invention to provide a functional chair with massage balls that is capable of allowing the massage balls to protrude outwardly therefrom through the manipulation of armrests to massage a user's back region, thereby improving functional limitations in study or office chairs only having a sitting function.

It is another object of the present invention to provide a functional chair with massage balls that is used as both of a massage chair for massaging a user's back muscle and erector spinae muscle and a general chair according to the user's selection.

To accomplish the above-mentioned objects, according to the present invention, there is provided a functional chair with massage balls including: a seat having a given thickness; a seat support disposed on the underside of the seat to support the seat and having casters mounted on one side thereof to move the seat; a backrest coupled to one side of the seat in such a manner as to be erected in up and down directions and having a plurality of massage holes formed penetratedly thereon in such a manner as to be spaced apart from each other at given intervals; a backrest support mounted on the rear side of the backrest and having an open surface formed penetratedly on the center thereof and an inside partition extended from edges of the open surface; a pair of massage parts rotatably mounted on the backrest support and having the massage balls protruding from the massage holes or inserted into the massage holes, while rotating; a pair of armrests fixed to one side of the massage parts to rotate the massage parts so that the massage balls protrude from the massage holes; a seat connector having one side fixed to the seat and the other side fixed to the backrest support to fix the seat and the backrest thereto; and a stopper mounted on the backrest support or the massage parts to control rotation of the massage parts.

According to the present invention, desirably, the massage parts include: massage plates erected in up and down directions; roller brackets protruding from on one side of the massage plates and having the massage balls rotatably mounted on ends thereof; and first rotation shafts and second rotation shafts disposed extended in up and down directions on upper and lower sides of the massage plates, the second rotation shafts having a pair of support rods extended therefrom in a horizontal direction, the pair of support rods having fastening holes formed on ends thereof, and the massage parts further include an elastic member disposed between the pair of support rods to elastically support the massage parts so that if a pressurizing force pressurizing the armrests is released, the protruding massage balls are inserted into the massage holes.

According to the present invention, desirably, the stopper has a given thickness and includes a plurality of fixing grooves concavedly formed on one side surface thereof, so that the fixing grooves are fitted to the roller brackets to allow the stopper to be fixedly mounted, and the massage plates come into contact with the side surface of the stopper to allow the rotation of the massage parts to be restricted.

According to the present invention, desirably, the stopper includes: a stopper housing disposed on the inner surface of the backrest support and having a rail hole extended in up and down directions; a stopper body fitted to a stopper insertion slot formed penetratedly on the inside partition in such a manner as to slide upward and downward and thus to come into contact with the massage plates or to release the contact so as to control the rotation of the massage plates; and a stopper handle mounted in the rail hole in such a manner as to be exposed to the outside of the backrest support to manipulate the upward and downward movements of the stopper body.

According to the present invention, desirably, the stopper handle includes: a first support plate coming into close contact with the outer surface of the stopper housing and having a handle exposed to the outside of the backrest support; a second support plate coming into close contact with the inner surface of the stopper housing; and a guide bar passing through the rail hole and having one side and the other side connected to the first support plate and the second support plate, the rail hole including: a sliding hole extended to slide the guide bar therealong; a fixing rail hole formed on one side of the sliding hole in such a manner as to seat the guide bar thereonto; and a stop protrusion formed between the sliding hole and the fixing rail hole in such a manner as to support the guide bar thereagainst to maintain a state where the guide bar is seated onto the fixing rail hole.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view showing a functional chair with massage balls according to the present invention;

FIG. 2 is an exploded perspective view showing main components of a backrest, a backrest support, and massage parts of the functional chair with massage balls according to the present invention;

FIGS. 3a and 3b are perspective views showing operating states of a stopper in the functional chair with massage balls according to the present invention;

FIGS. 4a and 4b are sectional and plan views showing another example in operating states of the massage parts and stopper in the functional chair with massage balls according to the present invention;

FIGS. 5a and 5b are sectional and plan views showing other operating states of the massage part and stopper in the functional chair with massage balls according to the present invention;

FIG. 6 is a partially perspective view showing main components of a stopper housing of the stopper in the functional chair with massage balls according to the present invention; and

FIG. 7 is a partially perspective view showing main components of the stopper in the functional chair with massage balls according to the present invention.

### DETAILED DESCRIPTION OF THE PREFERRED EMBODIMENTS

Hereinafter, an explanation on a functional chair with massage balls according to the present invention will be given in detail with reference to the attached drawings.

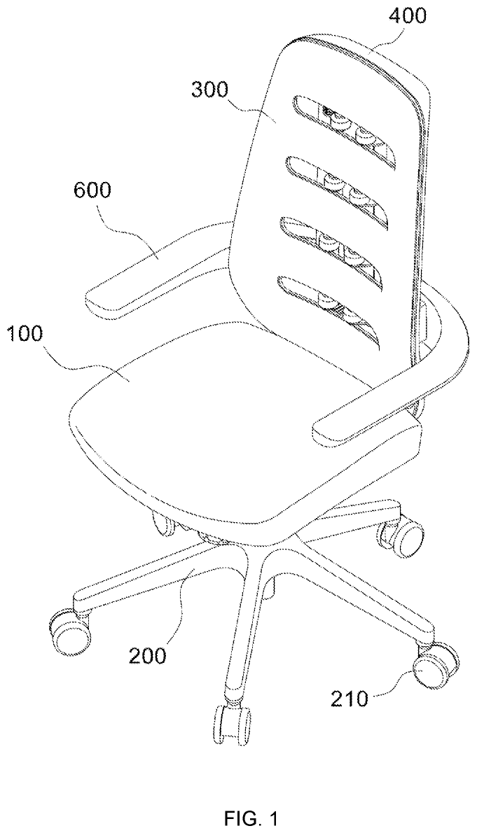

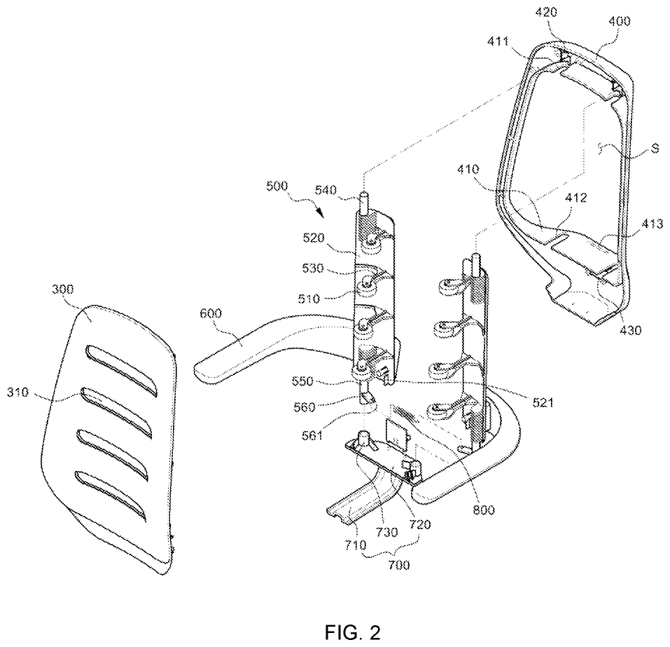

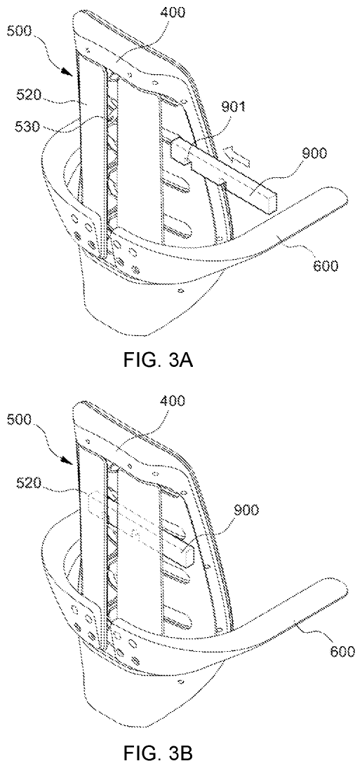

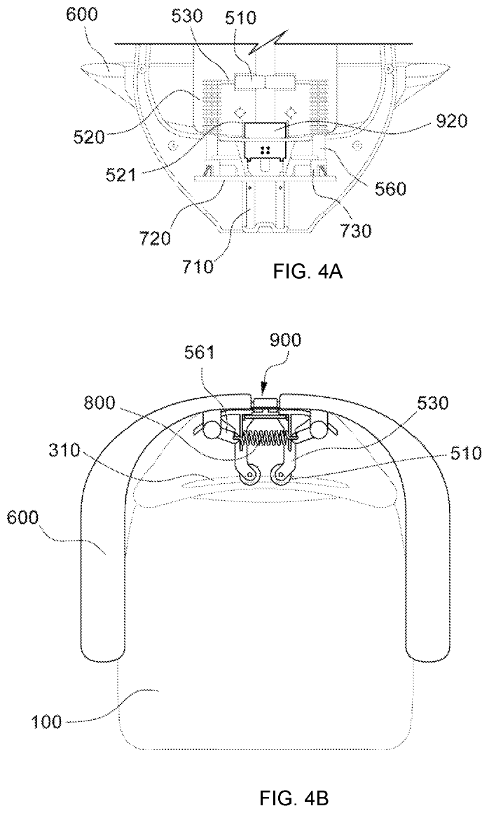

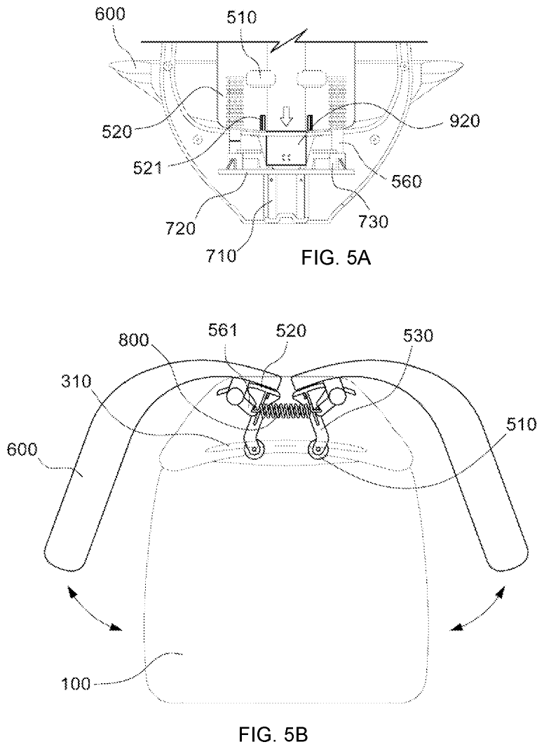

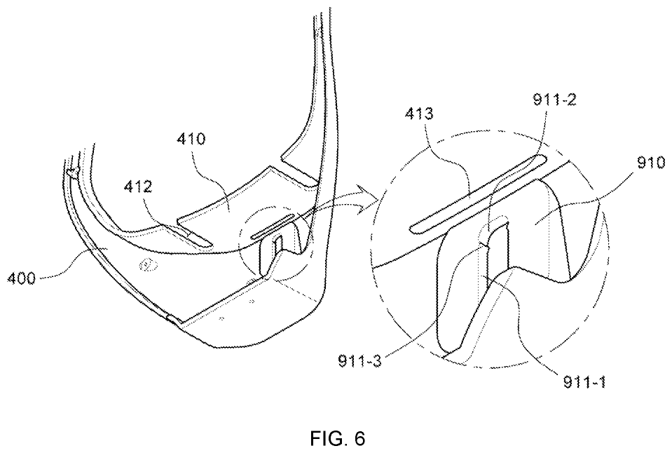

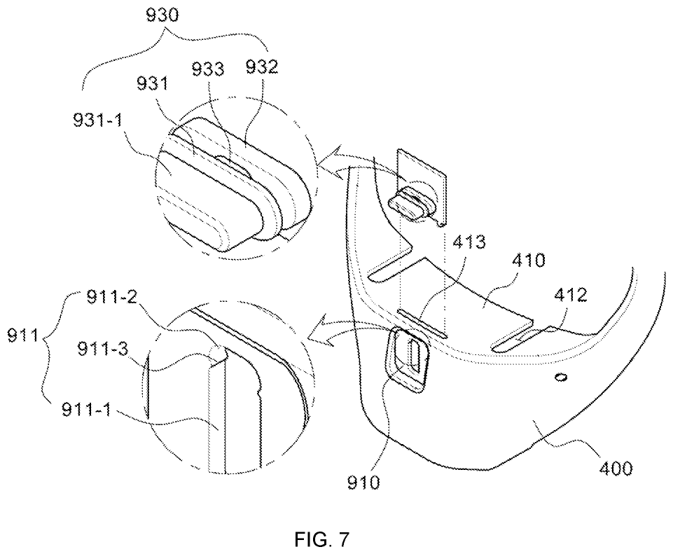

FIG. 1 is a perspective view showing a functional chair with massage balls according to the present invention, FIG. 2 is an exploded perspective view showing main components of a backrest, a backrest support, and massage parts of the functional chair with massage balls according to the present invention, FIGS. 3a and 3b are perspective views showing operating states of a stopper in the functional chair with massage balls according to the present invention, FIGS. 4a and 4b are sectional and plan views showing another example in operating states of the massage parts and stopper in the functional chair with massage balls according to the present invention, FIGS. 5a and 5b are sectional and plan views showing other operating states of the massage part and stopper in the functional chair with massage balls according to the present invention, FIG. 6 is a partially perspective view showing main components of a stopper housing of the stopper in the functional chair with massage balls according to the present invention, and FIG. 7 is a partially perspective view showing main components of the stopper in the functional chair with massage balls according to the present invention.

According to the present invention, as shown in FIG. 1, a functional chair with massage balls, which has the same structure as a general chair, includes a seat 100, a pair of armrests 600, a backrest 300, and a seat support 200 adapted to allow the seat 100 to be spaced apart from the floor and having casters 210 mounted thereon to easily move the seat 100.

At this time, the seat 100 has a given thickness and is made of a material having a buffering effect (for example, sponge, foamed urethane, and the like). The seat support 200 is disposed on the underside of the seat 100 to support the seat 100 thereagainst.

As shown in FIGS. 1 and 2, the backrest 300 is coupled to one side of the seat 100 in such a manner as to be erected in up and down directions in a state of being slant to a given angle, and if a user sits in the seat 100, he or she feels comfortable in the seat 100. At this time, the backrest 300 has a plurality of massage holes 310 formed penetratedly thereon in such a manner as to be spaced apart from each other at given intervals in up and down directions.

On the other hand, a backrest support 400 is mounted on the rear side of the backrest 300 to support the backrest 300 thereagainst. The backrest support 400 serves to support edges of the backrest 300 to prevent the backrest 300 from being deformed by the user's weight.

In detail, the backrest support 400 has an open surface S formed penetratedly on the center thereof and an inside partition 410 formed along edges of the open surface S to prevent the backrest support 400 from being twisted.

At this time, as shown in FIGS. 1 to 4b, a pair of massage parts 500 is rotatably mounted on the backrest support 400 to massage a back region of the user who sits in the seat 100. Each massage part 500 has a plurality of massage balls 510 spaced apart from each other at given intervals, and as the massage parts 500 rotate, at this time, the massage balls 510 protrude outwardly from the massage holes 310 or are inserted into the massage holes 310 to pressurize the user's back region or to release the back region from the pressurized state.

Rotating the massage parts 500 is controlled by means of the pair of armrests 600. In detail, the armrests 600 are fixed to one side of the massage parts 500, and if the armrests 600 are pushed to left and right directions by the user to rotate the massage parts 500, the massage balls 510 protrude from the massage holes 310.

Further, as shown in FIG. 2, a seat connector 700 is disposed between the seat 100 and the backrest support 400 to fix the seat 100, the backrest 300, and the backrest support 400 to each other. The formation of the seat connector 700 improves the durability of the seat 100, the backrest 300, and the backrest support 400.

As shown in FIGS. 3a and 3b, a stopper 900 is mounted on the massage parts 500 disposed on the backrest support 400 to control the rotation of the massage parts 500. The stopper 900 is inserted into a space between the backrest support 400 and the massage parts 500 to stop the rotation of the massage parts 500. In detail, the stopper 900 is grasped by the user and is then inserted into the space between the backrest support 400 and the massage parts 500. If it is desired to apply massage through the armrests 600, on the other hand, the stopper 900 is drawn from the space between the backrest support 400 and the massage parts 500 to rotate the massage parts 500.

Referring to FIG. 2, the massage parts 500 include massage plates 520, roller brackets 530, first rotation shafts 540, and second rotation shafts 550. First, each massage plate 520 has a given thickness and is erected in up and down directions. Desirably, the massage plates 520 are disposed in the open surface S of the backrest support 400.

The roller brackets 530 are disposed on one side surface of each massage plate 520 and have the massage balls 510 rotatably mounted on ends thereof. The roller brackets 530 are rotatable unitarily with the massage plates 520.

The first rotation shafts 540 and the second rotation shafts 550 are located extended upwardly and downwardly on upper and lower sides of the massage plates 520 in such a manner as to be formed integrally with the massage plates 520. Accordingly, the massage plates 520 are rotatable around the first rotation shafts 540 and the second rotation shafts 550.

As shown in FIGS. 2, 4a, 4b, 5a and 5b, support rods 560 are extended from the second rotation shafts 550 in crossing (horizontal) directions with respect to the extended directions of the second rotation shafts 550. As a result, a pair of support rods 560 is formed on the respective second rotation shafts 550. Each support rod 560 has a fastening hole 561 formed penetratedly on an end thereof.

At this time, an elastic member 800 is disposed between the pair of support rods 560, and one side and the other side of the elastic member 800 are fixed to the fastening holes 561 of the support rods 560 to elastically support the pair of massage plates 520. After the armrests 600 are pressurized by the user to rotate the massage plates 520, in detail, if the pressurizing force against the armrests 600 is released to allow the massage balls 510 protruding outwardly to be inserted into the massage holes 310, the massage plates 520 and the armrests 600 are returned to their original position by means of the elastic force of the elastic member 800.

On the other hand, the elastic member 800 may be formed of coil springs disposed between the second rotation shafts 550 and second support holders 730 or between the first rotation shafts 540 and first support holders 420. If the elastic member 800 is formed of the coil springs, assembling and maintenance are convenient, and also, the armrests 600 are independently controllable.

As shown in FIGS. 3a and 3b, the stopper 900 has a given thickness capable of being inserted into the space between the backrest support 400 and the massage parts 500 and includes a plurality of fixing grooves 901 concavedly formed on one side surface thereof in such a manner as to be spaced apart from each other at given intervals.

If the stopper 900 is insertedly mounted into the space between the backrest support 400 and the massage parts 500, in detail, the fixing grooves 901 are fitted to the roller brackets 530 so that the stopper 900 is fixedly mounted. At this time, the shapes of the fixing grooves 901 are machined correspondingly to the shapes of the roller brackets 530.

As the stopper 900 is mounted, like this, the massage plates 520 come into contact with the side surface of the stopper 900 to restrict the rotation of the massage parts 500.

Referring to FIG. 2, the first support holders 420 are disposed on the inner surface of the backrest support 400, that is, on one surface of the backrest support 400 facing the backrest 300 to support the first rotation shafts 540 thereagainst. Desirably, the first support holders 420 are disposed on the top of the backrest support 400 in such a manner as to support the side peripheries of the end portions of the first rotation shafts 540 to allow the massage plates 520 to gently rotate in the open surface S.

Further, the backrest support 400 has a seat connector coupling protrusion 430 protruding from the lower side thereof to fix the seat connector 700 thereto, and the seat connector coupling protrusion 430 and the seat connector 700 are fixed to each other by means of a separate fixing piece.

At this time, the inside partition 410 has upper fitting grooves 411 through which the first rotation shafts 540 are passed and lower fitting grooves 412 through which the second rotation shafts 550 are passed. The upper fitting grooves 411 and the lower fitting grooves 412 face each other. As the peripheries of the upper fitting grooves 411 and the lower fitting grooves 412 come into close contact with the side peripheries of the first rotation shafts 540 and the second rotation shafts 550, the upper fitting grooves 411 and the lower fitting grooves 412 serve to support the first rotation shafts 540 and the second rotation shafts 550. While the massage plates 520 is rotating, as a result, occurrence of gaps on the first rotation shafts 540 and the second rotation shafts 550 is minimized to permit the massage plates 520 to gently rotate.

As shown in FIG. 2, the seat connector 700 includes a seat connection rod 710 and a massage part fixing plate 720. One side of the seat connection rod 710 is coupled to one side of the seat 100, and the seat connection rod 710 has a shape of a plate having a given thickness in such a manner as to be bent on the other side thereof. At this time, the massage part fixing plate 720 is disposed on the other side bent of the seat connection rod 710. The massage part fixing plate 720 has a shape of a plate having a given thickness in such a manner as to be coupled to the seat connector coupling protrusion 430.

At this time, the pair of second support holders 730 is disposed on top of the massage part fixing plate 720 so as to insert the pair of second rotation shafts 550 thereinto, and the second rotation shafts 550 are rotatably inserted into the second support holders 730. Accordingly, the massage plates 520 are rotatable around the first rotation shafts 540 and the second rotation shafts 550.

According to another embodiment of the present invention, referring to FIGS. 2 to 7, a stopper 900 is mounted on the backrest support 400 to control the rotation of the massage parts 500. Through the manipulation of the stopper 900, the massage can be performed.

The stopper 900 includes a stopper housing 910, a stopper body 920, and a stopper handle 930. First, the stopper housing 910 is disposed on the inner surface of the backrest support 400, desirably on the lower side thereof and has a rail hole 911 formed on the center thereof in such a manner as to be extended in up and down directions.

The stopper body 920 is fitted to a stopper insertion slot 413 formed penetratedly on the inside partition 410 in such a manner as to slide upward and downward. Through the upward and downward movements of the stopper body 920, the massage plates 520 come into contact with the stopper body 920, so that the rotation of the massage plates 520 is controlled. In detail, if the stopper body 920 moves upward to come into contact with the massage plates 520, the rotation of the massage plates 520 is stopped, and if the stopper body 920 moves downward to release the massage plates 520 from the contacted state therewith, the massage plates 520 freely rotate.

On the other hand, stop protrusions 521 protrude from one side of the massage plates 520 in such a manner as to come into contact with the stopper body 920. As the stopper body 920 is supported against the stop protrusions 521, the rotation of the massage plates 520 is controlled.

The stopper handle 930 is mounted on one side of the stopper body 920 in such a manner as to be grasped by the user to manipulate the upward and downward movements of the stopper body 920. At this time, the stopper handle 930 is mounted in the rail hole 911 and guidedly moved along the extended direction of the rail hole 911. The stopper handle 930 is exposed to the outside of the backrest support 400 and is thus grasped by the user.

Referring to FIG. 7, the stopper handle 930 includes a first support plate 931, a second support plate 932, and a guide bar 933. The first support plate 931 comes into close contact with the outer surface of the stopper housing 910 and has a handle 931-1 disposed on one side thereof in such a manner as to be exposed to the outside of the backrest support 400 and thus grasped by the user.

The second support plate 932 protrudes from the side surface of the stopper body 920 in such a manner as to come into close contact with the inner surface of the stopper housing 910. At this time, the first support plate 931 is spaced apart from the second support plate 932 by a given distance, and the given distance is the same as the thickness of the stopper housing 910.

The guide bar 933 has a given diameter passing through the rail hole 911 and is disposed between the first support plate 931 and the second support plate 932. At this time, one side and the other side of the rail hole 911 are connected to the first support plate 931 and the second support plate 932, so that the first support plate 931 and the second support plate 932 come into close contact with the outer and inner surfaces of the stopper housing 910.

Referring to FIGS. 6 and 7, the rail hole 911 is divided into a sliding hole 911-1 and a fixing rail hole 911-2. The sliding hole 911-1 is extended upward and downward to move the stopper body 920 as well as the guide bar 933 in up and down directions. Desirably, the fixing rail hole 911-2 is formed on top of the sliding hole 911-1 in such a manner as to allow the guide bar 933 to come close contact therewith and to be thus seated thereonto, thereby maintaining the state where the stopper body 920 supports the massage plates 520.

At this time, a stop protrusion 911-3 is formed between the sliding hole 911-1 and the fixing rail hole 911-2. The stop protrusion 911-3 serves to support the guide bar 933 thereagainst so as to maintain the state where the guide bar 933 is seated onto the fixing rail hole 911-2, that is, so as to prevent the guide bar 933 seated onto the fixing rail hole 911-2 from moving downward due to its own weight. If the handle 931-1 is grasped by the user and is thus manipulated by means of application of a force over a given torque, accordingly, the stopper body 920 can be moved upward and downward, together with the guide bar 933.

As described above, the functional chair with massage balls according to the present invention is used normally as the study or office chair, and through the manipulation of the armrests disposed on both sides thereof, allows the massage balls mounted on the backrest to pressurize the user's muscles around the back or spine, thereby inducing blood circulation and providing posture correction effects.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A functional chair with massage balls comprising:
a seat having a given thickness;
a seat support disposed on the underside of the seat to support the seat and having casters mounted on one side thereof to move the seat;
a backrest coupled to one side of the seat in such a manner as to be erected in up and down directions and having a plurality of massage holes formed penetratedly thereon in such a manner as to be spaced apart from each other at given intervals;
a backrest support mounted on the rear side of the backrest and having an open surface formed penetratedly on the center thereof and an inside partition extended from edges of the open surface;
a pair of massage parts rotatably mounted on the backrest support and having the massage balls protruding from the massage holes or inserted into the massage holes, while rotating;
a pair of armrests fixed to one side of the massage parts to rotate the massage parts so that the massage balls protrude from the massage holes;
a seat connector having one side fixed to the seat and the other side fixed to the backrest support to fix the seat and the backrest thereto; and
a stopper mounted on the backrest support or the massage parts to control rotation of the massage parts.

2. The functional chair according to claim 1, wherein the massage parts comprise:
massage plates erected in up and down directions;
roller brackets protruding from on one side of the massage plates and having the massage balls rotatably mounted on ends thereof; and
first rotation shafts and second rotation shafts disposed extended in up and down directions on upper and lower sides of the massage plates, the second rotation shafts having a pair of support rods extended therefrom in a horizontal direction, the pair of support rods having fastening holes formed on ends thereof, and
the massage parts further comprise an elastic member disposed between the pair of support rods to elastically support the massage parts so that if a pressurizing force pressurizing the armrests is released, the protruding massage balls are inserted into the massage holes.

3. The functional chair according to claim 1, wherein the stopper has a given thickness and comprises a plurality of fixing grooves concavedly formed on one side surface thereof, so that the fixing grooves are fitted to the roller brackets to allow the stopper to be fixedly mounted, and the massage plates come into contact with the side surface of the stopper to allow the rotation of the massage parts to be restricted.

4. The functional chair according to claim 1, wherein the stopper comprises:
a stopper housing disposed on the inner surface of the backrest support and having a rail hole extended in up and down directions;
a stopper body fitted to a stopper insertion slot formed penetratedly on the inside partition in such a manner as to slide upward and downward and thus to come into contact with the massage plates or to release the contact so as to control the rotation of the massage plates; and
a stopper handle mounted in the rail hole in such a manner as to be exposed to the outside of the backrest support to manipulate the upward and downward movements of the stopper body.

5. The functional chair according to claim 4, wherein the stopper handle comprises:
a first support plate coming into close contact with the outer surface of the stopper housing and having a handle exposed to the outside of the backrest support;
a second support plate coming into close contact with the inner surface of the stopper housing; and
a guide bar passing through the rail hole and having one side and the other side connected to the first support plate and the second support plate, the rail hole comprising:
a sliding hole extended to slide the guide bar therealong;
a fixing rail hole formed on one side of the sliding hole in such a manner as to seat the guide bar thereonto; and
a stop protrusion formed between the sliding hole and the fixing rail hole in such a manner as to support the guide bar thereagainst to maintain a state where the guide bar is seated onto the fixing rail hole.
